(19) United States
(12) Patent Application Publication
(10) Pub. No.: US 2012/0170846 A1
(43) Pub. Date: Jul. 5, 2012

(54) METHOD FOR DETECTING STREAK NOISES IN DIGITAL IMAGE

(75) Inventor: Ming-Hsi Lin, Taitung County (TW)

(73) Assignee: ALTEK CORPORATION, Hsinchu City (TW)

(21) Appl. No.: 13/212,216

(22) Filed: Aug. 18, 2011

(30) Foreign Application Priority Data
Dec. 31, 2010 (TW) 99147217

(51) Int. Cl. G06K 9/34

(52) U.S. Cl. 382/173

(57) ABSTRACT

A method for detecting streak noises in a digital image including the following steps is provided. Firstly, an exposure value of a camera is decreased, and a digital image is captured under exposure with a homogeneous background light source by the camera. Secondly, a circular region of interest (ROI) is extracted from the digital image. Next, projection values of the circular ROI corresponding to a plurality of rotation angles are calculated. Then, the projection values are respectively converted into amplitudes of the rotation angles. Afterwards, a maximum amplitude is found from the amplitudes. Finally, the maximum amplitude is compared with a threshold value to judge whether a streak noise exists in the digital image.

### CROSS-REFERENCE TO RELATED APPLICATION

This application claims the priority benefit of Taiwan application Ser. No. 99147217, filed on Dec. 31, 2010. The entirety of the above-mentioned patent application is hereby incorporated by reference herein and made a part of this specification.

### BACKGROUND OF THE INVENTION

1. Field of the Invention

The present invention generally relates to an image detection method, in particular, to a method for detecting streak noises in an image.

2. Description of Related Art

With the progress of technology, digital cameras have gradually replaced film cameras and become a mainstream tool for recording life. The digital cameras mostly utilize a photosensitive element such as a charge-coupled device (CCD) and a complementary metal-oxide-semiconductor (CMOS) for imaging. In the imaging process of the photosensitive element, a streaky noise image is sometimes generated due to the electromagnetic wave interference of electronic elements. The streak noise easily occurs in an image captured through brightness compensation with low brightness and high ISO, because it is necessary to amplify a signal during brightness compensation, which also amplifies noises, and thus affects the image quality.

Such streaky noises usually have a specific angle and are distributed throughout the entire image picture. Interference produced by different electronic elements usually results in noises of different fringe frequencies in the image. For example, as the influences of electronic shutter, CCD extraction frequency, and oscillation are different, the fringe frequencies of the image are also different. Generally, the detection of streaky noises requires recognition with human eyes.

However, noise fringes at high frequency are subtle, so that human eye recognition consumes a lot of time and labor.

### SUMMARY OF THE INVENTION

Accordingly, the present invention is directed to a method for detecting streak noises, which is capable of automatically detecting streak noises.

The present invention provides a method for detecting streak noises in a digital image, which includes the following steps. A circular region of interest (ROI) of a digital image is extracted. Projection values of the circular ROI corresponding to a plurality of rotation angles are calculated. The projection values are converted into amplitudes of the rotation angles. A maximum amplitude is found from the amplitudes. The maximum amplitude is compared with a threshold value, so as to judge whether a streak noise exists in the digital image.

In an embodiment of the present invention, before the step of extracting the circular ROI of the digital image, the method further includes the following step. An exposure value (EV) of a camera is decreased, and the digital image is captured under exposure with a homogeneous light source by the camera.

In an embodiment of the present invention, the method for detecting streak noises in a digital image further includes calculating a streak angle of the streak noise according to the maximum amplitude.

In an embodiment of the present invention, the step of calculating the streak angle includes the following steps. An angle corresponding to the maximum amplitude is calculated. The angle is corrected, so as to calculate the streak angle.

In an embodiment of the present invention, before the step of calculating the projection values of the circular ROI corresponding to the rotation angles, the method further includes the following step. If the circular ROI is a color image, the circular ROI is converted into a gray-scale image.

In an embodiment of the present invention, before the step of finding the maximum amplitude, the method further includes performing a level correction on the circular ROI.

In an embodiment of the present invention, the method for detecting streak noises in a digital image further includes substituting the maximum amplitude in a gamma curve.

In an embodiment of the present invention, the step of calculating the projection values of the circular ROI corresponding to the rotation angles includes calculating the projection values of the circular ROI corresponding to the rotation angles by using a Radon transform algorithm.

In an embodiment of the present invention, the step of converting the projection values into the amplitudes includes converting the projection values into the amplitudes by using a fast Fourier transform algorithm.

In an embodiment of the present invention, before the step of extracting the circular ROI of the digital image, the method for detecting streak noises in a digital image further includes reading a folder, so as to fetch a file of the digital image from the folder.

In an embodiment of the present invention, the method for detecting streak noises in a digital image further includes the following steps. A test result indicating whether the streak noise exists in the digital image is recorded. It is judged whether another digital image exists in the folder. If yes, the process returns to the step of extracting the circular ROI.

In an embodiment of the present invention, the method for detecting streak noises in a digital image further includes comparing the amplitudes other than the maximum amplitude with the threshold value, so as to judge whether another streak noise exists in the digital image.

Based on the above, in the method for detecting streak noises of the present invention, projection values of a circular ROI corresponding to various angles are converted into amplitudes, and then a maximum amplitude is compared with a threshold value, so as to judge whether a streak noise exists. Therefore, it can be automatically judged whether a streak exists; moreover, the obtained data is objective, and errors in subjective judgment due to human factors are reduced.

In order to make the aforementioned and other objectives, features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view of a method for detecting streak noises according to a first embodiment of the present invention.

FIG. 2 is a schematic view of a digital image applied in the process of FIG. 1.

FIGS. 3A and 3B are respectively schematic views illustrating projection of the digital image in FIG. 2 before and after a circular ROI is extracted.

FIG. 4 is a schematic view illustrating a process of a method for detecting streak noises according to another embodiment of the present invention.

FIGS. 5A and 5B are respectively schematic views of a brightness average value before and after a level correction.

FIGS. 6A and 6B are respectively views illustrating Fourier transform before and after the level correction.

FIG. 7 is a schematic view illustrating projection of a digital image according to another embodiment.

FIG. 8 is a schematic view of a gamma curve applied in the process of FIG. 4.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

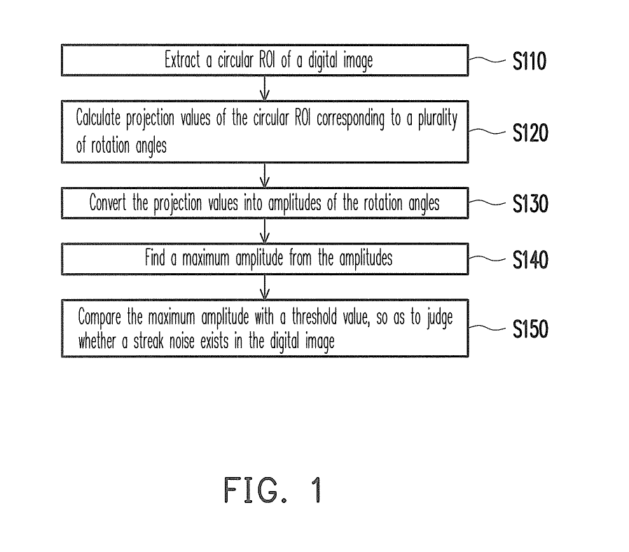

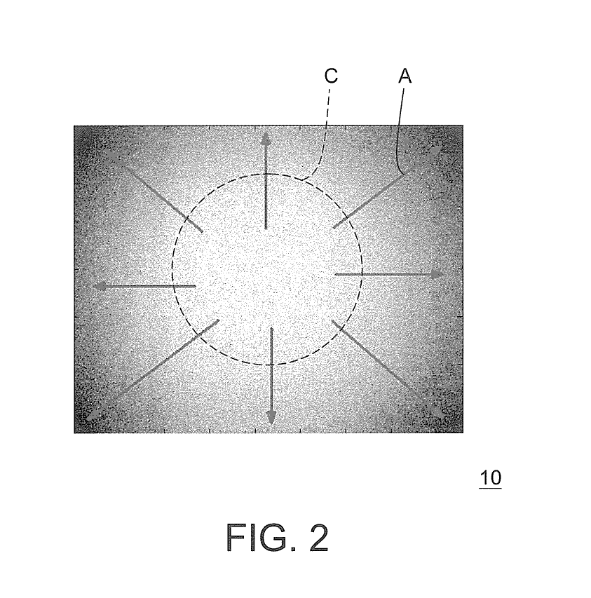

FIG. 1 is a view of a method for detecting streak noises according to a first embodiment of the present invention, and FIG. 2 is a schematic view of a digital image applied in the process of FIG. 1. Referring to FIGS. 1 and 2, firstly, Step S110 is performed, in which a circular ROI C of a digital image 10 is extracted. Next, Step S120 is performed, in which projection values of the circular ROI C corresponding to a plurality of rotation angles are calculated. For example, the projection values of the circular ROI C corresponding to the rotation angles may be calculated by using a Radon transform algorithm. Then, Step S130 is performed, in which the projection values are converted into amplitudes of the rotation angles. For example, the projection values may be converted into the amplitudes by using a fast Fourier transform algorithm. Further, Step S140 is performed, in which a maximum amplitude is found from the amplitudes. Afterwards, Step S150 is performed, in which the maximum amplitude is compared with a threshold value, so as to judge whether a streak noise exists in the digital image.

It should be noted that, in this embodiment, projection values of a circular ROI corresponding to various angles are converted into amplitudes, and then a maximum amplitude is compared with a threshold value, so as to judge whether a streak noise exists. Therefore, it can be automatically judged whether a streak exists; moreover, the obtained data is objective, and errors in subjective judgment due to human factors are reduced.

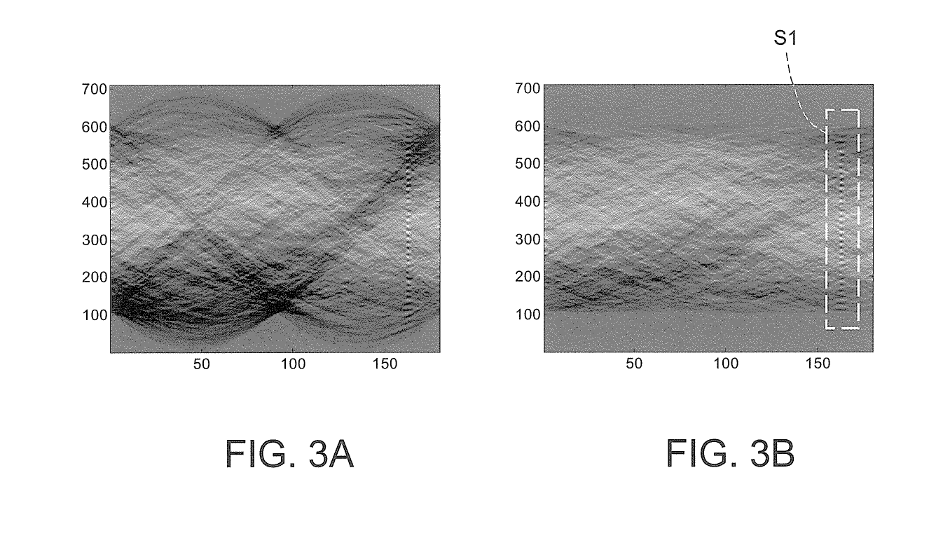

In addition, in FIG. 2, arrow A represents the influence of limb darkening of an optical system on the digital image 10, and the farther in the direction pointed by the arrow A, the more evident the effect of limb darkening. In this embodiment, the circular ROI C has a diameter of for example, 500 pixels, and is rotated by 0-180°. FIGS. 3A and 3B are respectively schematic views illustrating projection of the digital image in FIG. 2 before and after the circular ROI is extracted. Referring to FIGS. 3A and 3B, a streak noise S1 occurs at a position where maximum brightness and minimum brightness appear alternately, in which the vertical axis represents pixels, and the horizontal axis represents the angle by which the image is rotated. Upon comparison of the two figures, during the rotation, the part in the digital image 10 other than the circular ROI C is not only projected on upper and lower regions in FIG. 3A, but also affects the projection of the circular ROI C in the center, thereby producing errors.

Therefore, in the state that the circular ROI C is extracted, the projection result as shown in FIG. 3B is presented, so that the errors in the limb darkening of the optical system and the projection can be eliminated.

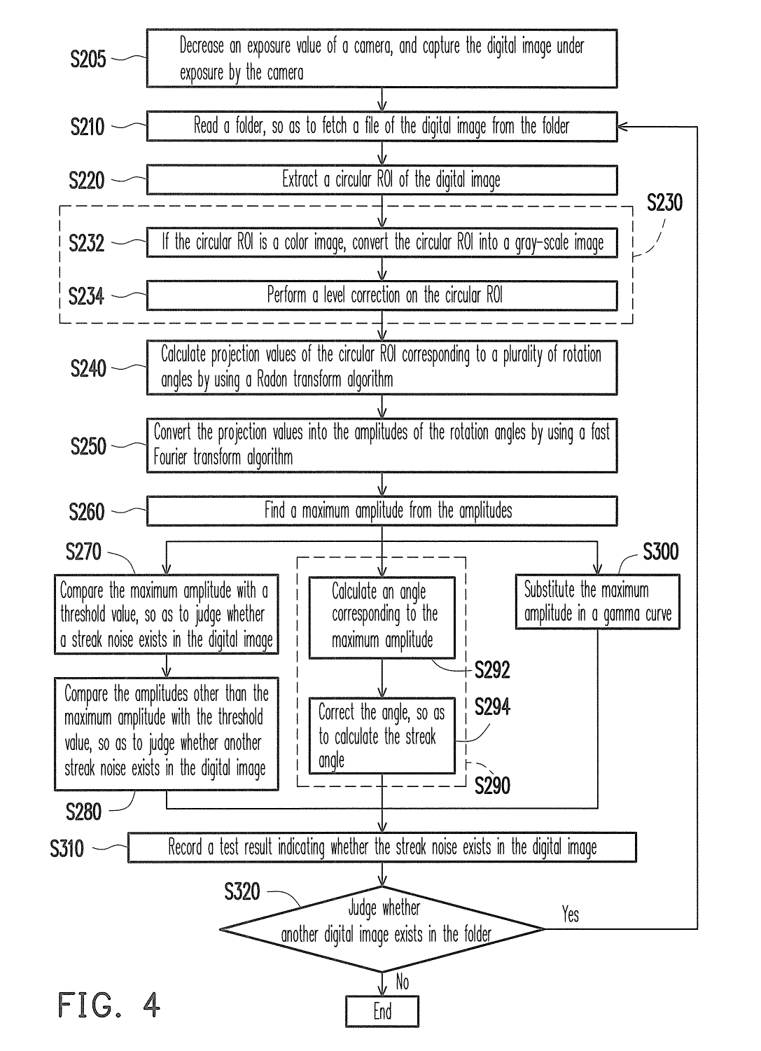

FIG. 4 is a schematic view illustrating a process of a method for detecting streak noises according to another embodiment of the present invention. For ease of illustration, the method for detecting streak noises in FIG. 4 is illustrated with reference to FIGS. 2 and 3B, but the present invention is not limited to this. Firstly, Step S205 is performed, in which an exposure value of a camera is decreased, and the digital image is captured under exposure with a homogeneous light source by the camera. For example, the homogeneous light source may be a light box with a set value of LV 10, and the exposure value is, for example, adjusted to −1 to −3 EV. Afterwards, Step S210 is performed, in which a folder (not shown) is read, so as to fetch a file of the digital image 10 from the folder. Then, Step S220 is performed, in which the circular ROI C of the digital image 10 is extracted.

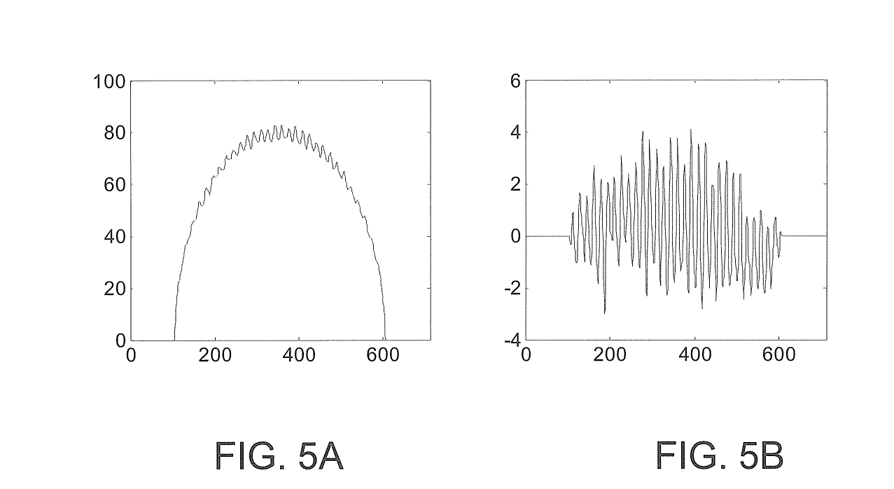

Next, Step S230 is performed, in which preprocessing is performed on the digital image. In this embodiment, Step S230 may include two sub-steps of Step S232 and Step S234. Firstly, Step S232 is performed, in which if the circular ROI is a color image, the circular ROI C may be converted into a gray-scale image in a bright mode, so as to improve the accuracy of texture recognition. Afterwards, Step S234 is performed, in which a level correction is performed on the circular ROI C. FIGS. 5A and 5B are respectively schematic views of a brightness average value before and after the level correction. Referring to FIGS. 5A and 5B, the original waveform oscillates up and down in the range of 0-100, while the corrected waveform substantially remains close to 0, in which the vertical axis represents amplitude, and the horizontal axis represents pixels.

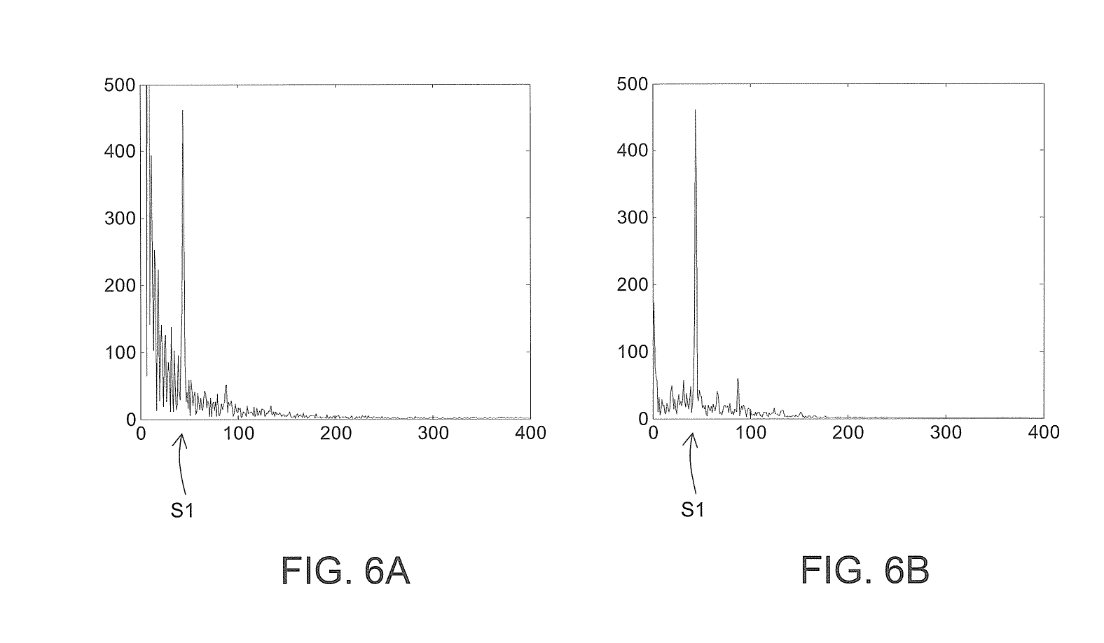

Then, Step 5240 is performed, in which projection values of the circular ROI C corresponding to the rotation angles may be calculated by using a Radon transform algorithm. Afterwards, Step S250 is performed, in which the projection values are converted into the amplitudes by using a fast Fourier transform algorithm. FIGS. 6A and 6B are respectively views illustrating Fourier transform before and after the level correction. Firstly, Referring to FIGS. 5A and 6A, in the view illustrating Fourier transform before the level correction, amplitudes of a signal T generated at low frequency and the streak noise S1 are larger than those of signals at other positions, so the signal T may affect the later judgment of the streak noise S1. Then, referring to

FIGS. 5B and 6B, after the correction, the low-frequency signal does not affect the later judgment of the streak noise S1. That is, in this embodiment, brightness correction can be performed by setting the level of the brightness average value of the circular ROI C to zero, so as to reduce the phenomenon of level shifting produced in fast Fourier transform, and achieve more accurate energy analysis.

Then, Step S260 is performed, in which a maximum amplitude is found from the amplitudes. In this embodiment, the maximum amplitude may be found by search; while in another embodiment not shown, the maximum amplitude in the amplitudes may be found by using discrete cosine transform (DCT) and a low-pass filter in combination, but the present invention is not limited to this. Afterwards, Step S270 is performed, in which the maximum amplitude is compared with a threshold value, so as to judge whether a streak noise exists in the digital image 10.

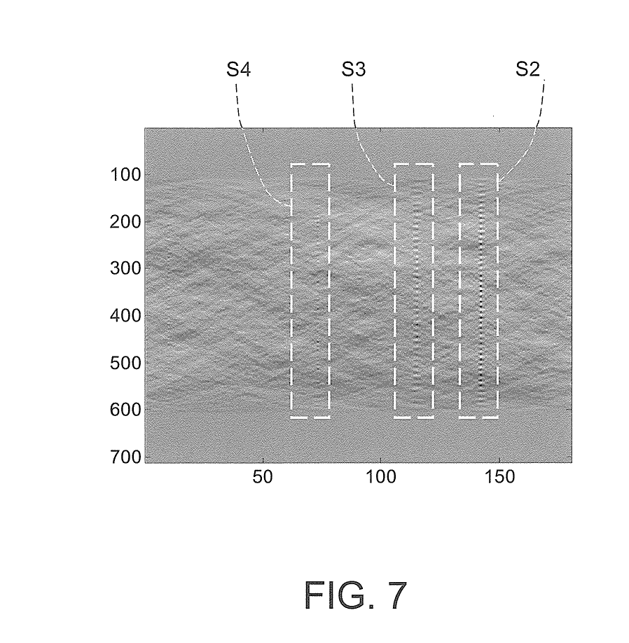

In this embodiment, after Step S270 is completed, Step S280 may further be performed, in which the amplitudes other than the maximum amplitude are compared with the threshold value, so as to judge whether another streak noise exists in the digital image 10. In this embodiment, the digital image 10 has only one streak noise S1. FIG. 7 is a schematic view illustrating projection of a digital image according to another embodiment. As shown in FIG. 7, according to energy intensity, streak noises S2, S3, and S4 are respectively a primary interference noise, a secondary interference noise, and a minor interference noise. In FIG. 7, a plurality of amplitudes may be obtained by performing fast Fourier transform on the projection values, and then all amplitudes higher than the threshold value are found from the amplitudes, so as to judge whether noises of different frequencies exist at the same time.

Steps S290 and S300 may be processed in parallel with Step S270, but the present invention is not limited to this. As for Step S290, a streak angle of the streak noise may be calculated according to the maximum amplitude. In particular, Step S290 may include two sub-steps of Step S292 and Step S294. Firstly, Step S292 is performed, in which an angle corresponding to the maximum amplitude is calculated. Then, Step S294 is performed, in which the angle is corrected, so as to calculate the streak angle. That is, fast Fourier transform is performed on various angles to obtain that angle a corresponds to the maximum amplitude S, and angle α is corrected to obtain angle θ, in which θ is the streak angle.

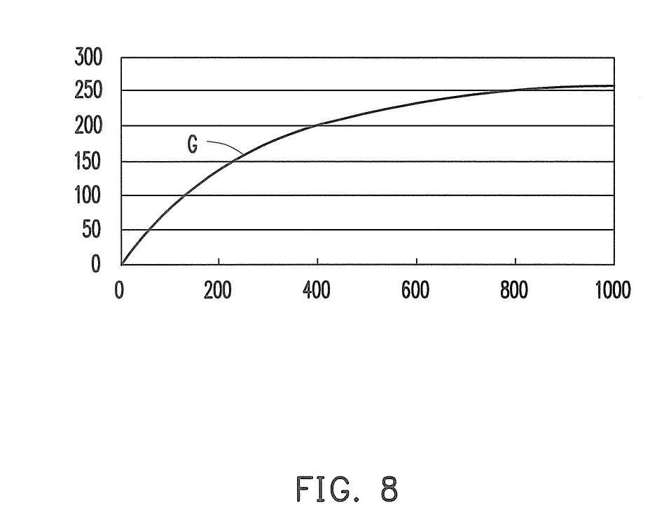

FIG. 8 is a schematic view of a gamma curve applied in the process of FIG. 4. Referring to FIG. 8, as for Step S300, the maximum amplitude may be substituted in a gamma curve G, so as to obtain a hue intensity value conforming to human eye vision. In addition, after Steps S270, S290, and S300 are completed, Step S310 may further be performed, in which a test result indicating whether the streak noise exists in the digital image is recorded. Then, Step S320 is performed, in which it is judged whether another digital image exists in the folder. If yes, the process returns to Step S210 in which the folder is read so as to fetch the file of the digital image from the folder, and then the circular ROI is extracted. Thereby, a plurality of files in the folder can be judged, so as to save the time for human eye observation. In addition, the above steps may be developed into human-machine interfaces, and may be performed directly by using execution files.

Based on the above, in the method for detecting streak noises of the present invention, projection values of a circular ROI corresponding to various angles are converted into amplitudes, and then a maximum amplitude is compared with a threshold value, so as to judge whether a streak noise exists. Therefore, it can be automatically judged whether a streak exists; moreover, the obtained data is objective, and errors in subjective judgment due to human factors are reduced. In addition, in the present invention, a level correction can be performed on the circular ROI, so as to reduce the phenomenon of level shifting produced in fast Fourier transform, and achieve more accurate energy analysis. Further, in the present invention, not only it can be judged whether the streak noise exists, but also the streak angle of the streak noise can be calculated according to the maximum amplitude.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detecting streak noises in a digital image, comprising:
extracting a circular region of interest of a digital image;
calculating projection values of the circular region of interest corresponding to a plurality of rotation angles;
converting the projection values into amplitudes of the rotation angles;
finding a maximum amplitude from the amplitudes; and
comparing the maximum amplitude with a threshold value, so as to judge whether a streak noise exists in the digital image.

2. The method for detecting streak noises in a digital image according to claim 1, wherein before the step of extracting the circular region of interest of the digital image, the method further comprises:
decreasing an exposure value of a camera, and capturing the digital image under exposure with a homogeneous light source by the camera.

3. The method for detecting streak noises in a digital image according to claim 1, further comprising:
calculating a streak angle of the streak noise according to the maximum amplitude.

4. The method for detecting streak noises in a digital image according to claim 3, wherein the step of calculating the streak angle comprises:
calculating an angle corresponding to the maximum amplitude; and
correcting the angle, so as to calculate the streak angle.

5. The method for detecting streak noises in a digital image according to claim 1, wherein before the step of calculating the projection values of the circular region of interest corresponding to the rotation angles, the method further comprises:
if the circular region of interest is a color image, converting the circular region of interest into a gray-scale image.

6. The method for detecting streak noises in a digital image according to claim 1, wherein before the step of finding the maximum amplitude, the method further comprises:
performing a level correction on the circular region of interest.

7. The method for detecting streak noises in a digital image according to claim 1, further comprising:
substituting the maximum amplitude in a gamma curve.

8. The method for detecting streak noises in a digital image according to claim 1, wherein the step of calculating the projection values of the circular region of interest corresponding to the rotation angles comprises:
calculating the projection values of the circular region of interest corresponding to the rotation angles by using a Radon transform algorithm.

9. The method for detecting streak noises in a digital image according to claim 1, wherein the step of converting the projection values into the amplitudes comprises:
converting the projection values into the amplitudes by using a fast Fourier transform algorithm.

10. The method for detecting streak noises in a digital image according to claim 1, wherein before the step of extracting the circular region of interest of the digital image, the method further comprises:
reading a folder, so as to fetch a file of the digital image from the folder.

11. The method for detecting streak noises in a digital image according to claim 10, further comprising:
recording a test result indicating whether the streak noise exists in the digital image;
judging whether another digital image exists in the folder; and
if yes, returning to the step of extracting the circular region of interest.

12. The method for detecting streak noises in a digital image according to claim 1, further comprising:
comparing the amplitudes other than the maximum amplitude with the threshold value, so as to judge whether another streak noise exists in the digital image.
